(19) United States
(12) Patent Application Publication
(10) Pub. No.: US 2005/0232070 A1
(43) Pub. Date: Oct. 20, 2005

(54) Stirring device for a discharge processing machine

(75) Inventor: Chin-Juei Tung, Yungkang City (TW)

Correspondence Address: Dennison, Schultz & Dougherty & Macdonald, 1727 King Street, Suite 105, Alexandria, VA, 22314, US

(73) Assignee: YIHAWJET ENTERPRISES CO., LTD.

(21) Appl. No.: 10/825,234

(22) Filed: Apr. 16, 2004

(51) Int. Cl. B01F 13/02

(52) U.S. Cl. 366/101; 366/106; 366/136; 366/137

(57) ABSTRACT

A stirring device for an electrical discharge machine includes an air output device adapted to be immersed in the tank, a high pressure tank adapted to be in communication with the tank by a connection tube and a unidirectional valve in communication with the high pressure tank and the tank to control whether air in the high pressure tank flows to the air output device to stir the processing liquid and the processing particle in the tank or the electrical discharge machine.

### BACKGROUND OF THE INVENTION

1. Field of the Invention

The present invention relates to a stirring device, and more particularly to a stirring device for a discharge processing machine to stir up the processing particles in the processing liquid received in a tank of the discharge processing machine, such that the processing particles are evenly spread on a workpiece being processed.

2. Description of Related Art

A discharge processing machine is used to process a molded product to have the product surface covered with evenly distributed particles. The addition of the particles is to increase the fine surface effect of the molded product. Thus, after the process of the discharge processing machine, the molded product surface is smooth and extremely fine. Although the addition of the specific particle in the processing liquid is able to increase the surface effect of the molded product, the concentration of the added particles in the processing liquid has great disadvantage to the discharge effect. As a result of being not soluable in the processing liquid, the added particle concentration in the processing liquid is increased gradually. That is, due to the gravity effect on the particles, the processing particles descend to the processing liquid tank and only a small amount of processing particles is suspended in the processing liquid. Therefore, the discharge processing effect to the product immersed in the processing liquid is not as good as expected.

Furthermore, when a period of time has passed with the discharge processing machine not having been used, the added particles entirely descend to the bottom of the processing liquid tank. Therefore, before restarting the discharge processing machine, manual work is required to stir up the descended particles in the processing liquid so as to accomplish the even discharge effect of the discharge processing machine.

To overcome the shortcomings, the present invention tends to provide an improved stirring device to mitigate the aforementioned problems.

### SUMMARY OF THE INVENTION

The primary objective of the present invention is to provide an improved stirring device to help stir up the descended particles in the processing liquid so as to accomplish the even discharge effect of the discharge processing machine.

Other objects, advantages and novel features of the invention will become more apparent from the following detailed description when taken in conjunction with the accompanying drawings.

### BRIEF DESCRIPTION OF THE DRAWINGS

FIG. 1 is a schematic view showing the application of the stirring device with the discharge processing machine;

FIG. 2 is a schematic view showing the application of the stirring device with a different type of discharge processing machine; and

FIG. 3 is a schematic view showing the operational status of the stirring device cooperated with the discharge processing machine.

### DETAILED DESCRIPTION OF THE PREFERRED EMBODIMENT

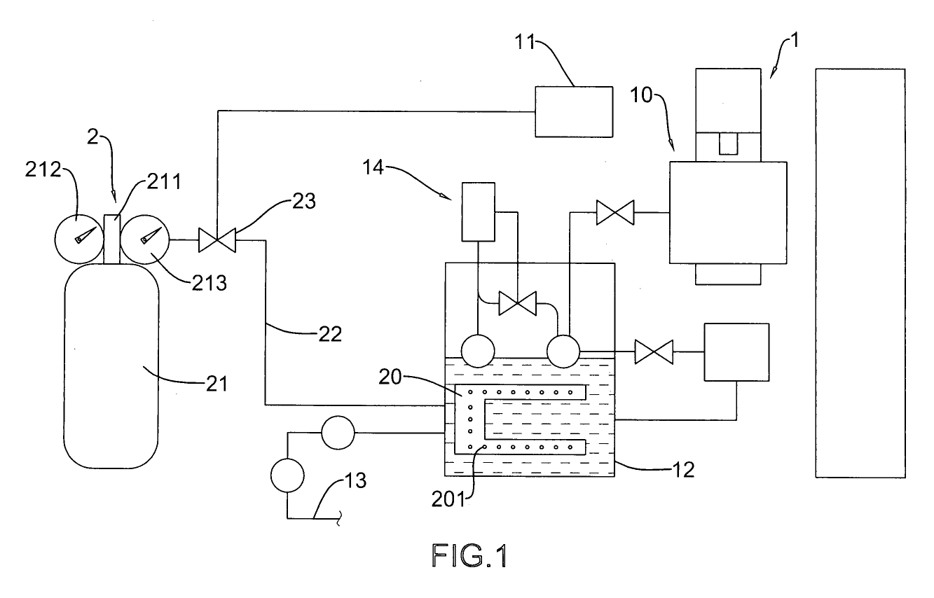

With reference to FIG. 1, the discharge processing machine cooperated with the stirring device of the present invention includes a discharge unit (1) for providing electrical discharge to a product to be processed, a processing unit (10) for providing electrodes to the product so that the product is electrical-discharge processed, a tank (12) for receiving therein processing liquid and processing particles and a recycling tube (13) for recycling the processing liquid from the tank (12).

The stirring device (2) constructed in accordance with the present invention includes an air output device (20) and a high pressure tank (21) preferably containing therein nitrogen.

The air output device (20) is a hollow body received in the tank (12) and provided with multiple air holes (201) defined through a surface of the hollow body. The air output device (20) is connected to and communicated with the high pressure tank (21) by a connection tube (22). The high pressure tank has a first pressure gauge (212) to show the air pressure in the high pressure tank (21), a second pressure gauge (213) to show the air pressure flowing out of the high pressure tank (21) and a connector (211) in connection with the connection tube (22). A unidirectional valve (23) controlled by a controller (11) of the discharge processing machine is provided in the connection tube (22) to control whether the air in the high pressure tank (21) flows to the air output device (20). An auxiliary filtering device (14) may be added to communicate with the tank (12) so as to help the even distribution of the added particles in the tank (12).

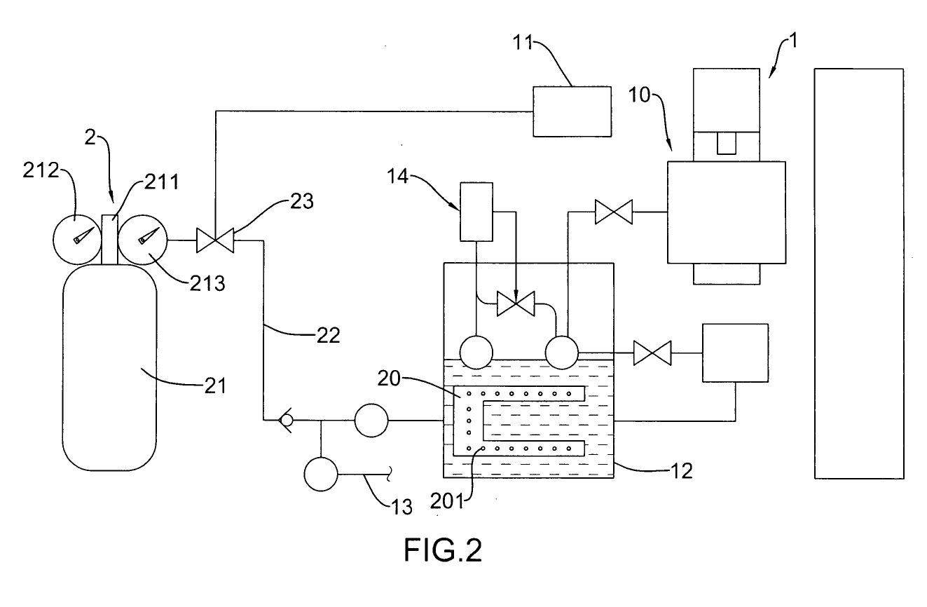

With reference to FIG. 2, it is noted that the connection tube (22) is in communication with the recycling tube (13).

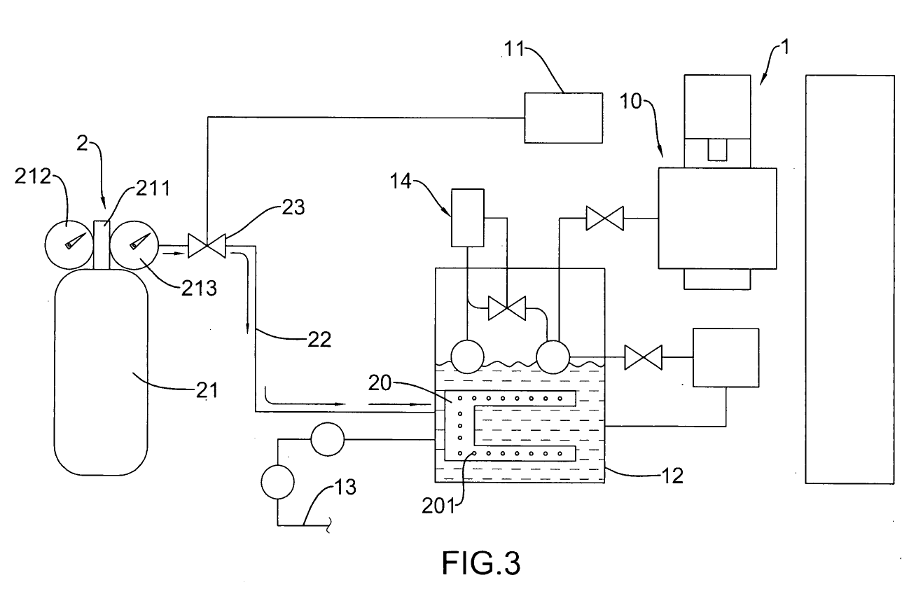

With reference to FIG. 3, when the stirring device is cooperated with the discharge processing device, the controller (11) opens the unidirectional valve (23) to allow the air to flow out of the high pressure tank (21). In the meantime, the first pressure gauge (212) indicates the air pressure in the high pressure tank (21) and the second pressure gauge (213) indicates the air pressure flowing out of the high pressure tank (21). Subsequently, the air flowing out of the high pressure tank (21) flows to the air output device (20) and into the air holes (201) to stir up the processing liquid in the tank (12).

As well known in the art, after the addition of air in a liquid, the liquid is stirred such that the processing particles in the processing liquid in the tank (12) are evenly distributed. As a result of even distribution of the processing particles in the tank, the electrical discharge processing procedure to the product is able to be accomplished evenly.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A stirring device for an electrical discharge machine having a discharge unit for providing electrical discharge to a product to be processed, a processing unit for providing electrodes to the product so that the product is electrical-discharge processed, a tank for receiving therein processing liquid and processing particles and a recycling tube for recycling the processing liquid from the tank, the stirring device comprising:
an air output device adapted to be immersed in the tank;
a high pressure tank adapted to be in communication with the tank by a connection tube; and
a unidirectional valve in communication with the high pressure tank and the tank to control whether air in the high pressure tank flows to the air output device to stir the processing liquid and the processing particle.

2. The stirring device as claimed in claim 1, wherein the high pressure tank has a first pressure gauge to indicate air pressure in the high pressure tank and a second pressure gauge to indicate air pressure flowing out of the high pressure tank.

3. The stirring device as claimed in claim 2, wherein the high pressure tank has a connector mounted on the high pressure tank for connection with the connection tube.

4. The stirring device as claimed in claim 1, wherein the connection tube is adapted to communicate with the recycling tube.

5. The stirring device as claimed in claim 3, wherein the connection tube is adapted to communicate with the recycling tube.

6. The stirring device as claimed in claim 1, wherein the air output device is a hollow body with multiple air holes defined through a surface of the hollow body to allow the air from the high pressure tank to flow into the tank.

7. The stirring device as claimed in claim 3, wherein the air output device is a hollow body with multiple air holes defined through a surface of the hollow body to allow the air from the high pressure tank to flow into the tank.

8. The stirring device as claimed in claim 4, wherein the air output device is a hollow body with multiple air holes defined through a surface of the hollow body to allow the air from the high pressure tank to flow into the tank.

9. The stirring device as claimed in claim 5, wherein the air output device is a hollow body with multiple air holes defined through a surface of the hollow body to allow the air from the high pressure tank to flow into the tank.

10. The stirring device as claimed in claim 6, wherein the high pressure tank contains therein nitrogen.

11. The stirring device as claimed in claim 7, wherein the high pressure tank contains therein nitrogen.

12. The stirring device as claimed in claim 8, wherein the high pressure tank contains therein nitrogen.

13. The stirring device as claimed in claim 9, wherein the high pressure tank contains therein nitrogen.
